(19) United States
(12) Patent Application Publication
(10) Pub. No.: US 2022/0025108 A1
(43) Pub. Date: Jan. 27, 2022

(54) TWO-PACK CURABLE EPOXY RESIN COMPOSITION, CURED PRODUCT, FIBER-REINFORCED COMPOSITE MATERIAL AND MOLDED ARTICLE

(71) Applicant: DIC Corporation, Tokyo (JP)

(72) Inventors: Nana Sugimoto, Ichihara-shi (JP); Makoto Kimura, Ichihara-shi (JP); Atsuko Kobayashi, Ichihara-shi (JP)

(73) Assignee: DIC Corporation, Tokyo (JP)

(21) Appl. No.: 17/295,983

(22) PCT Filed: Oct. 24, 2019
(86) PCT No.: PCT/JP2019/041661

§ 371 Date: May 21, 2021

(30) Foreign Application Priority Data
Nov. 29, 2018 (JP) 2018-223583

(51) Int. Cl. C08G 59/42; C08G 59/24; C08G 59/68; C08J 5/04

(52) U.S. Cl. CPC C08G 59/4223; C08G 59/245; C08J 2363/02; C08J 5/04; C08G 59/688

(57) ABSTRACT

The present invention provides: a two-pack curable epoxy resin composition that contains a curing agent having excellent long-term storage stability, has a low viscosity and a good impregnation property into fibers; the cured product; a fiber-reinforced composite material; and a molded article. Specifically, the two-pack curable epoxy resin composition is used, the two-pack curable epoxy resin composition containing: a main agent (i) containing an epoxy resin (A); and a curing agent (ii) containing an acid anhydride (B) and an organic phosphorus compound (C), in which a mass ratio [(i)/(ii)] of the main agent (i) to the curing agent (ii) is in a range of 35/65 to 75/25, and an amount of the organic phosphorus compound (C) used is in a range of 0.5 to 5 parts by mass with respect to 100 parts by mass in total of the epoxy resin (A) and the acid anhydride (B).

### TECHNICAL FIELD

The present invention relates to: a two-pack curable epoxy resin composition that has a low viscosity and a good impregnation property into fibers, and is capable of forming a cured product having excellent mechanical properties, heat resistance, and surface smoothness; the cured product; a fiber-reinforced composite material; and a molded article.

### BACKGROUND ART

In recent years, fiber-reinforced resin molded articles reinforced with reinforcing fibers have attracted attention for their light weight and excellent mechanical strength, and are being widely used in various structural applications such as housings for automobiles, aircrafts, and ships, and various members. The fiber-reinforced resin molded article can be produced by molding the fiber-reinforced composite material by a molding method such as a filament winding method, a press molding method, a hand lay-up method, a pultrusion method, or an RTM method.

The fiber-reinforced composite material is obtained by impregnating the reinforcing fiber with a resin. Since the resin used for the fiber-reinforced composite material is required to have stability at room temperature, and durability, strength and the like of the cured product, a thermosetting resin such as an unsaturated polyester resin, a vinyl ester resin, or an epoxy resin is generally used. Among them, the epoxy resin is being put to practical use in various applications as a resin for the fiber-reinforced composite material because the cured product having high strength, elastic modulus, and excellent heat resistance can be obtained.

As the epoxy resin for the fiber-reinforced composite material, as described above, the reinforcing fiber is impregnated with the resin and used, so that the epoxy resin is required to have a low viscosity. In addition, when the fiber-reinforced resin molded article is used for a structural part around an engine in an automobile or the like, and for an electric wire core material, a resin having excellent heat resistance and mechanical strength in the cured product is required so that the fiber-reinforced resin molded article can withstand a severe usage environment for a long period of time.

As the epoxy resin, for example, an epoxy resin composition containing a bisphenol type epoxy resin, an acid anhydride, and an imidazole compound is widely known (see, for example, PTL 1). Further, an epoxy resin composition in which a divalent phenol glycidyl ether and a glycidyl amine type epoxy resin are used in combination and combined with a curing agent is also known (see, for example, PTL 2). However, although the epoxy resin compositions provided in PTLs 1 and 2 have high impregnation properties into the reinforcing fiber and exhibit certain performances in heat resistance and mechanical strength of the cured products, since three liquids of the epoxy resin, the curing agent (acid anhydride), and a curing accelerator are mixed, there have been problems such as a measurement error due to the number of mixed liquids and a mixing error due to a complicated mixing process.

As a means for solving the above problems, a two-pack curing system in which the curing accelerator is added to the curing agent (acid anhydride) has been proposed, but in an epoxy/acid anhydride curing system such as the epoxy resin composition described in PTL 1, an imidazole compound is often used as the curing accelerator, and even if such a curing accelerator is added to the cured product (acid anhydride), there has been a concern that carbon dioxide gas may be generated by decarboxylation reaction of the acid anhydride. Not only may this lead to lack of long-term storage stability, such as causing expansion of a container when stored as the curing agent, but also a mixture using such a curing accelerator has had problems that the decarboxylation reaction occurs even during curing with the epoxy resin, the cured product having a smooth surface cannot be obtained, and the like.

Therefore, there has been a demand for an epoxy resin composition having excellent impregnation property into the reinforcing fiber, which contains the curing agent having excellent long-term storage stability that does not easily cause the decarboxylation reaction, and an epoxy resin composition capable of forming the cured product having excellent mechanical properties, heat resistance and surface smoothness.

### CITATION LIST

### Patent Literature

PTL 1: JP-A-2010-163573

PTL 2: WO2016/148175

### SUMMARY OF INVENTION

### Technical Problem

Therefore, a problem to be solved by the present invention is to provide: the two-pack curable epoxy resin composition that contains the curing agent having excellent long-term storage stability, has a low viscosity and a good impregnation property into fibers, and is capable of forming the cured product having excellent mechanical properties, heat resistance, and surface smoothness; the cured product; the fiber-reinforced composite material; and the molded article.

### Solution to Problem

As a result of diligent research to solve the above problems, the present inventors have found that the above problems can be solved by using in a specific mass ratio a main agent containing the epoxy resin, and the curing agent containing the acid anhydride and a specific amount of an organic phosphorus compound, and have completed the present invention.

That is, the present invention relates to: a two-pack curable epoxy resin composition containing a main agent (i) containing an epoxy resin (A), and a curing agent (ii) containing an acid anhydride (B) and an organic phosphorus compound (C), in which a mass ratio [(i)/(ii)] of the main agent (i) to the curing agent (ii) is in a range of 35/65 to 75/25, and an amount of the organic phosphorus compound (C) used is in a range of 0.5 to 5 parts by mass with respect to 100 parts by mass in total of the epoxy resin (A) and the acid anhydride (B); a cured product of the two-pack curable epoxy resin composition; a fiber-reinforced composite material using the two-pack curable epoxy resin composition; and a molded article.

### Advantageous Effects of Invention

The two-pack curable epoxy resin composition of the present invention contains the curing agent having excellent long-term storage stability that does not cause the decarboxylation reaction, has a low viscosity and a good impregnation property into fibers, and the cured product obtained has excellent mechanical properties, heat resistance, and surface smoothness, so that it can be suitably used for the fiber-reinforced composite material or the like. Note that the “excellent mechanical properties” in the present invention refer to high strength and high elastic modulus.

### DESCRIPTION OF EMBODIMENTS

A two-pack curable epoxy resin composition of the present invention contains a main agent (i) and a curing agent (ii).

As the main agent (i), an epoxy resin (A) is indispensably used.

Examples of the epoxy resin (A) include bisphenol type epoxy resin, biphenyl type epoxy resin, novolak type epoxy resin, triphenylmethane type epoxy resin, tetraphenylethane type epoxy resin, dicyclopentadiene-phenol addition reaction type epoxy resin, alcohol type epoxy resin, phenol aralkyl type epoxy resin, epoxy resin having a naphthalene skeleton in a molecular structure, phosphorus atom-containing epoxy resin and the like. These epoxy resins can be used alone or in combination of two or more.

Examples of the bisphenol type epoxy resin include bisphenol A type epoxy resin, bisphenol F type epoxy resin, and the like.

Examples of the biphenyl type epoxy resin include tetramethylbiphenyl type epoxy resin and the like.

Examples of the novolak type epoxy resin include phenol novolac type epoxy resin, cresol novolac type epoxy resin, bisphenol A novolak type epoxy resin, epoxidized product of a condensate of phenols and aromatic aldehyde having a phenolic hydroxyl group, biphenyl novolac type epoxy resins, and the like.

Examples of the alcohol-type epoxy resin include diglycidyl ether of 1,4-butanediol and the like.

Examples of the epoxy resin having the naphthalene skeleton in the molecular structure include naphthol novolac type epoxy resin, naphthol aralkyl type epoxy resin, naphthol-phenol co-condensation novolac type epoxy resin, naphthol-cresol co-condensation novolak type epoxy resin, diglycidyloxy naphthalene, 1,1-bis(2,7-diglycidyloxy-1-naphthyl)alkane, and the like.

Among these epoxy resins, the bisphenol type epoxy resin is preferable because it has impregnation property into a reinforcing fiber and excellent heat resistance in a cured product of the resin.

Further, from a viewpoint of improving the impregnation property into the reinforcing fiber and a curing rate, an epoxy equivalent of the epoxy resin (A) is preferably in a range of 120 to 300 g/eq, and more preferably in a range of 130 to 230 g/eq.

A viscosity of the epoxy resin (A) at 20° C. to 40° C. is preferably in a range of 500 mPa-s to 200,000 mPa-s, and more preferably in a range of 1,000 mPa-s to 15,000 mPa-s, because the two-pack curable epoxy resin composition having excellent impregnation property into the reinforcing fiber can be obtained.

As the curing agent (ii), an acid anhydride (B) and an organic phosphorus compound (C) are indispensably used.

Examples of the acid anhydride (B) include tetrahydrophthalic anhydride, methyltetrahydrophthalic anhydride, hexahydrophthalic anhydride, methylhexahydrophthalic anhydride, methylendoethylenetetrahydrophthalic anhydride, trialkyltetrahydrophthalic anhydride, methylnadic anhydride, phthalic anhydride, trimellitic anhydride, pyromellitic anhydride, maleic anhydride, and the like. Among them, the methyltetrahydrophthalic anhydride and the methylhexahydrophthalic anhydride are preferable because they are liquid and have excellent impregnation property into fibers and workability. Further, these acid anhydrides can be used alone or in combination of two or more.

Among them, from the viewpoint of improving the impregnation property into the reinforcing fiber and the curing rate, an acid anhydride equivalent of the acid anhydride (B) is preferably in a range of 120 to 250 g/eq, and more preferably in a range of 150 to 190 g/eq.

Further, from a viewpoint of storage stability of the curing agent and mechanical properties of the epoxy resin composition, as the acid anhydride (B), an amount of free acid contained in the acid anhydride is preferably in a range of 0.05 to 2 mass %. Note that the “amount of free acid” in the present invention is a value calculated by the following method.

### [Calculation Method of Amount of Free Acid]

After dissolving a sample in acetonitrile, potentiometric titration is carried out with a 0.05 mol/l tri-n-propylamine acetone solution at pH 4.6 as an end point. At the same time, a blank test is carried out, and the amount of free acid is calculated by the following equation.

$$Amount of free acid ( mass \% ) = \frac{\begin{matrix}Molecular weight of free acid \times \\ ( V - B ) \times 0.05 \times 100\end{matrix}}{2 \times 1000 \times W} . \qquad [ Equation 1 ]$$

V; Titration of tri-n-propylamine solution required for sample (ml)

B; Titration of tri-n-propylamine solution required for blank test (ml)

W; Amount of sample (g)

Examples of the organic phosphorus compound (C) include: phosphine compounds such as triphenylphosphine, tris(4-methylphenyl)phosphine, tris(4-ethylphenyl)phosphine, tris(4-propylphenyl)phosphine, tris(4-butylphenyl)phosphine, tris(2,4-dimethylphenyl)phosphine, tris(2,4,6-trimethylphenyl)phosphine, tributyl phosphine, and trioctyl phosphine; phosphite compounds such as triphenyl phosphite, tris(nonylphenyl)phosphite, tris(2,4-di-tert-butylphenyl)phosphite, tridecyl phosphite, trioctyl phosphite, trioctadecyl phosphite, didecyl monophenyl phosphite, dioctyl monophenyl phosphite, diisopropyl monophenyl phosphite, and monobutyl diphenyl phosphite; and phosphate compounds such as trimethyl phosphate, triethyl phosphate, and triphenyl phosphate. Among them, trivalent organic phosphorus compounds such as phosphine compound and phosphite compound are preferable, and triphenylphosphine is particularly preferable, because the cured product having excellent curability and high heat resistance can be obtained. Further, the organic phosphorus compounds can be used alone or in combination of two or more.

The amount of the organic phosphorus compound (C) used is in a range of 0.5 to 5 parts by mass, and preferably in a range of 0.8 to 4 parts by mass with respect to 100 parts by mass in total of the epoxy resin (A) and the acid anhydride (B), from a viewpoint of achieving both impregnation property into the reinforcing fiber and mechanical properties.

Further, from a viewpoint of improving a balance between the curing rate, the heat resistance of the cured product, and the mechanical properties, it is more preferable to use the main agent (i) and the curing agent (ii) so that a ratio of the number of moles of acid anhydride group in the acid anhydride (B) to the number of moles of epoxy group in the epoxy resin (A), that is, “the number of moles of acid anhydride group”/“the number of moles of epoxy group” is in a range of 0.8 to 1.2.

As the curing agent (ii), in addition to the acid anhydride (B) and the organic phosphorus compound (C), other curing agents or curing accelerators may be used, if necessary.

As the other curing agents or curing accelerators, any of various compounds generally used as the curing agent or the curing accelerator for epoxy resins can be used. Examples of the compounds include: dicyandiamide, or amide compounds obtained by reacting an amine compound with an aliphatic dicarboxylic acid such as succinic acid, glutaric acid, adipic acid, pimelic acid, suberic acid or azelaic acid, or a carboxylic acid compound such as fatty acid or dimeric acid;

phenol resins such as novolak type phenol resin, triphenol methane type phenol resin, tetraphenol ethane type phenol resin, phenol or naphthol aralkyl type phenol resin, phenylene or naphthylene ether type phenol resin, dicyclopentadiene-phenol addition reaction type phenol resin, and phenolic hydroxyl group containing compound-alkoxy group-containing aromatic compound co-condensation type phenol resin, containing one or more kinds of various phenolic compounds such as polyhydroxybenzene, polyhydroxynaphthalene, biphenol compound, bisphenol compound, phenol, cresol, naphthol, bisphenol, and biphenol;

imidazole derivatives such as imidazole, 2-methylimidazole, 2-ethyl-4-methylimidazole, 2-phenylimidazole, 2-phenyl-4-methylimidazole, 1,2-dimethylimidazole, 1-benzyl-2-methylimidazole, 1-cyanoethyl-2-methylimidazole, and 1-cyanoethyl-2-phenylimidazole;

urea compounds such as p-chlorophenyl-N, N-dimethylurea, 3-phenyl-1,1-dimethylurea, 3-(3,4-dichlorophenyl)-N,N-dimethylurea, and N-(3-chloro-4-methylphenyl)-N′,N′-dimethylurea;

organic acid metal salt; Lewis acid; amine complex salt, and the like.

A mass ratio [(i)/(ii)] of the main agent (i) to the curing agent (ii) is in a range of 35/65 to 75/25, and preferably in a range of 40/60 to 70/30, from a viewpoint of achieving both heat resistance and mechanical properties.

The two-pack curable epoxy resin composition of the present invention may contain other resins other than the epoxy resin (A), and flame retardants/flame retardant aids, fillers, additives, and organic solvents as long as effects of the present invention are not impaired.

Examples of the other resins include polycarbonate resin, polyphenylene ether resin, phenol resin, curable resin other than the above, and thermoplastic resin.

Examples of the polycarbonate resin include polycondensate of divalent or bifunctional phenol and carbonyl halide, or a polymer obtained by polymerizing divalent or bifunctional phenol and carbonic acid diester by a transesterification method.

Here, examples of the divalent or bifunctional phenol that is a raw material of the polycarbonate resin include 4,4′-dihydroxybiphenyl, bis(4-hydroxyphenyl)methane, 1,1-bis(4-hydroxyphenyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 1,1-bis(4-hydroxyphenyl) cyclohexane, bis(4-hydroxyphenyl)ether, bis(4-hydroxyphenyl)sulfide, bis(4-hydroxyphenyl) sulfone, bis(4-hydroxyphenyl) sulfoxide, bis(4-hydroxyphenyl)ketone, hydroquinone, resorcin, and catechol. Among these divalent phenols, bis(hydroxyphenyl)alkanes are preferable, and those using 2,2-bis(4-hydroxyphenyl)propane as a main raw material are particularly preferable.

On the other hand, examples of the carbonyl halide or the carbonic acid diester that reacts with the divalent or bifunctional phenol include: phosgene; diaryl carbonates such as dihaloformate of divalent phenol, diphenyl carbonate, ditolyl carbonate, bis(chlorophenyl)carbonate, and m-cresyl carbonate; and aliphatic carbonate compounds such as dimethyl carbonate, diethyl carbonate, diisopropyl carbonate, dibutyl carbonate, diamyl carbonate, and dioctyl carbonate.

Further, the polycarbonate resin may have a straight-chain structure as a molecular structure of its polymer chain, and may have a branched structure in addition to this. The branched structure can be introduced by using as a raw material component 1,1,1-tris(4-hydroxyphenyl) ethane, α, α′, α″-tris (4-hydroxyphenyl)-1,3,5-triisopropylbenzene, fluoroglucin, trimellitic acid, isatinbis(o-cresol) and the like.

Examples of the polyphenylene ether resin include poly(2,6-dimethyl-1,4-phenylene)ether, poly(2-methyl-6-ethyl-14-phenylene)ether, poly(2,6-diethyl-1,4-phenylene)ether, poly(2-ethyl-6-n-propyl-1,4-phenylene)ether, poly(2,6-di-n-propyl-1,4-phenylene)ether, poly(2-methyl-6-n-butyl-1,4-phenylene)ether, poly(2-ethyl-6-isopropyl-1,4-phenylene)ether, and poly(2-methyl-6-hydroxyethyl-1,4-phenylene)ether. Among them, the poly(2,6-dimethyl-1,4-phenylene)ether is preferable.

Further, the polyphenylene ether resin may include as a partial structure a 2-(dialkylaminomethyl)-6-methylphenylene ether unit, a 2-(N-alkyl-N-phenylaminomethyl)-6-methylphenylene ether unit or the like.

Further, in the polyphenylene ether resin, a modified polyphenylene ether resin, in which a reactive functional group such as a carboxyl group, an epoxy group, an amino group, a mercapto group, a silyl group, a hydroxyl group or a dicarboxylic anhydride group is introduced into its resin structure by a method such as graft reaction or copolymerization, can also be used as long as an object of the present invention is not impaired.

Examples of the phenol resin include a resole-type phenol resin, a novolak-type phenol resin, a phenol aralkyl resin, a polyvinyl phenol resin, and a triazine-modified phenol novolac resin modified with melamine or benzoguanamine.

The curable resin, the thermoplastic resin and the like other than the above are not specified at all, but their examples include: polypropylene-based resin, polyethylene-based resin, polystyrene-based resin, syndiotactic polystyrene-based resin, ABS-based resin, AS-based resin, biodegradable resin; polyalkylene arylate-based resins such as polybutylene terephthalate, polyethylene terephthalate, polypropylene terephthalate, polytrimethylene terephthalate, and polyethylene naphthalate; and unsaturated polyester resin, vinyl ester resin, diallyl phthalate resin, cyanate resin, xylene resin, triazine resin, urea resin, melamine resin, benzoguanamine resin, urethane resin, oxetane resin, ketone resin, alkyd resin, furan resin, styrylpyridine resin, silicone resin and synthetic rubber. These resins can be used alone or in combination of two or more.

Examples of the flame retardants/flame retardant aids include a non-halogen-based flame retardant and the like.

Examples of the non-halogen-based flame retardant include a phosphorus-based flame retardant, a nitrogen-based flame retardant, a silicone-based flame retardant, an inorganic flame retardant, an organometallic salt-based flame retardant, and the like. These flame retardants can be used alone or in combination of two or more.

As the phosphorus-based flame retardant, either an inorganic phosphorus-based flame retardant or an organic phosphorus-based flame retardant can be used. Examples of the inorganic phosphorus-based flame retardant include ammonium phosphates such as red phosphorus, monoammonium phosphate, diammonium phosphate, triammonium phosphate, and ammonium polyphosphate and inorganic nitrogen-containing phosphorus compounds such as phosphate amide.

The red phosphorus is preferably subjected to surface treatment for a purpose of preventing hydrolysis and the like. Examples of a method of the surface treatment include (i) a method of coating with an inorganic compound such as magnesium hydroxide, aluminum hydroxide, zinc hydroxide, titanium hydroxide, bismuth oxide, bismuth hydroxide, bismuth nitrate or a mixture thereof, (ii) a method of coating with a mixture of an inorganic compound such as magnesium hydroxide, aluminum hydroxide, zinc hydroxide, or titanium hydroxide, and a thermosetting resin such as a phenol resin, and (iii) a method of double-coating a coating of the inorganic compound such as magnesium hydroxide, aluminum hydroxide, zinc hydroxide, or titanium hydroxide with the thermosetting resin such as a phenol resin.

Examples of the organic phosphorus-based flame retardant include general-purpose organic phosphorus-based compounds such as phosphoric acid ester compound, phosphonic acid compound, phosphinic acid compound, phosphine oxide compound, phosphorane compound, and organic nitrogen-containing phosphorus compound, as well as cyclic organic phosphorus compounds such as 9,10-dihydro-9-oxa-10-phosphaphenanthrene-10-oxide, 10-(2,5-dihydroxyphenyl)-10H-9-oxa-10-phosphaphenanthrene-10-oxide, and 10-(2,7-dihydroxynaphthyl)-10H-9-oxa-10-phosphaphenanthrene-10-oxide. In the present invention, the organic phosphorus-based flame retardant is different from the organic phosphorus compound (C).

Further, when the phosphorus-based flame retardant is used, hydrotalcite, magnesium hydroxide, boron compound, zirconium oxide, black dye, calcium carbonate, zeolite, zinc molybdate, activated charcoal and the like can also be used in combination with the phosphorus-based flame retardant.

Examples of the nitrogen-based flame retardant include triazine compound, cyanuric acid compound, isocyanuric acid compound, and phenothiazine. Among them, the triazine compound, the cyanuric acid compound, and the isocyanuric acid compound are preferable.

Examples of the triazine compound include melamine, acetoguanamine, benzoguanamine, melone, melam, succinoguanamine, ethylenedimelamine, polyphosphate melamine, and triguanamine, as well as aminotriazine sulfate compounds such as guanyl melamine sulfate, melem sulfate, and melam sulfate, and aminotriazine-modified phenolic resin, aminotriazine-modified phenolic resin further modified with tung oil, isomerized linseed oil, or the like.

Specific examples of the cyanuric acid compound include cyanuric acid and melamine cyanuric acid.

A blending amount of the nitrogen-based flame retardant is appropriately selected depending on a type of the nitrogen-based flame retardant, other components of the epoxy resin composition, and a desired degree of flame retardancy, but for example, in the two-pack curable epoxy resin composition of the present invention, a range of 0.05 mass % to 10 mass % is preferable, and a range of 0.1 mass % to 5 mass % is more preferable.

Further, when the nitrogen-based flame retardant is used, metal hydroxide, molybdenum compound, or the like can also be used in combination.

The silicone-based flame retardant can be used without particular limitation as long as it is an organic compound containing a silicon atom, and examples thereof include silicone oil, silicone rubber, silicone resin, and the like.

A blending amount of the silicone-based flame retardant is appropriately selected depending on a type of the silicone-based flame retardant, the other components of the epoxy resin composition, and the desired degree of flame retardancy, but for example, a range of 0.05 mass % to 20 mass % is preferable in the two-pack curable epoxy resin composition of the present invention. Further, when the silicone-based flame retardant is used, molybdenum compound, alumina or the like can also be used in combination.

Examples of the inorganic flame retardant include metal hydroxide, metal oxide, metal carbonate compound, metal powders, boron compound, low melting point glass, and the like.

Examples of the metal hydroxide include aluminum hydroxide, magnesium hydroxide, dolomite, hydrotalcite, calcium hydroxide, barium hydroxide, zirconium hydride, and the like.

Examples of the metal oxide include zinc molybdenum, molybdenum trioxide, zinc stannate, tin oxide, aluminum oxide, iron oxide, titanium oxide, manganese oxide, zirconium oxide, zinc oxide, molybdenum oxide, cobalt oxide, bismuth oxide, chromium oxide, nickel oxide, copper oxide, tungsten oxide, and the like.

Examples of the metal carbonate compound include zinc carbonate, magnesium carbonate, calcium carbonate, barium carbonate, basic magnesium carbonate, aluminum carbonate, iron carbonate, cobalt carbonate, titanium carbonate, and the like.

Examples of the metal powders include aluminum, iron, titanium, manganese, zinc, molybdenum, cobalt, bismuth, chromium, nickel, copper, tungsten, tin, and the like.

Examples of the boron compound include zinc borate, zinc metaborate, barium metaborate, boric acid, borax, and the like.

Examples of the low melting point glass include glassy compounds such as Seaplea (Bokusui Brown Co., Ltd.), hydrated glass SiO₂—MgO—H₂O, PbO—B₂O₃-based, ZnO—P₂O₅—MgO-based, P₂O₅—B₂O₃—PbO—MgO-based, P—Sn—O—F-based, PbO—V₂O₅—TeO₂-based, Al₂O₃—H₂O-based, and lead borosilicate-based, and the like.

A blending amount of the inorganic flame retardant is appropriately selected depending on a type of the inorganic flame retardant, the other components of the epoxy resin composition, and the desired degree of flame retardancy, but for example, in the two-pack curable epoxy resin composition of the present invention, a range of 0.05 mass % to 20 mass % is preferable, and a range of 0.5 mass % to 15 mass % is more preferable.

Examples of the organometallic salt-based flame retardant include ferrocene, acetylacetonate metal complex, organometallic carbonyl compound, organocobalt salt compound, organic sulfonic acid metal salt, a compound in which a metal atom and an aromatic compound or a heterocyclic compound are ionically bonded or coordinated.

A blending amount of the organometallic salt-based flame retardant is appropriately selected depending on a type of the organometallic salt-based flame retardant, the other components of the epoxy resin composition, and the desired degree of flame retardancy, but for example, a range of 0.005 mass % to 10 mass % is preferable in the two-pack curable epoxy resin composition of the present invention.

Examples of the fillers include titanium oxide, glass beads, glass flakes, glass fiber, calcium carbonate, barium carbonate, calcium sulfate, barium sulfate, potassium titanate, aluminum borate, magnesium borate, fused silica, crystalline silica, alumina, silicon nitride, aluminum hydroxide, and fibrous reinforcing agents such as kenaf fiber, carbon fiber, alumina fiber, and quartz fiber, and non-fibrous reinforcing agent. The fillers can be used alone or in combination of two or more. Further, the fillers may be coated with an organic substance, an inorganic substance or the like.

When the glass fiber is used as the filler, it can be selected from long fiber type roving, short fiber type chopped strand, milled fiber and the like. As the glass fiber, it is preferable to use a surface-treated material for the resin to be used. By blending the filler, strength of the non-combustible layer (or carbonized layer) generated during combustion can be further improved, the non-combustible layer (or carbonized layer) once formed during combustion is less likely to be damaged, and stable heat insulating ability can be obtained, so that a greater flame retardant effect can be obtained, and high rigidity can also be imparted to the material.

Examples of the additives include stabilizers such as plasticizer, antioxidant, ultraviolet absorber, and light stabilizer, and antistatic agent, conductivity-imparting agent, stress reliever, mold release agent, crystallization accelerator, hydrolysis inhibitor, lubricant, impact-imparting agent, slidability improver, compatibilizer, nucleating agent, strengthening agent, reinforcing agent, fluidity controlling agent, dye, sensitizer, coloring pigment, rubbery polymer, thickener, anti-settling agent, anti-sagging agent, defoamer, coupling agent, rust preventive agent, antibacterial/antifungal agent, antifouling agent, conductive polymer, and the like.

Examples of the organic solvents include methyl ethyl ketone acetone, dimethylformamide, methyl isobutyl ketone, methoxy propanol, cyclohexanone, methyl cellosolve, ethyl diglycol acetate, propylene glycol monomethyl ether acetate, and the like.

An exothermic temperature range in a differential scanning calorimetry (DSC) of the two-pack curable epoxy resin composition of the present invention, that is, “Endset temperature”-“Onset temperature” is preferably in a range of 20 to 38° C., because the two-pack curable epoxy resin composition having excellent impregnation property into the reinforcing fiber can be obtained and the reaction can be easily controlled.

An initial compound viscosity (hereinafter, abbreviated as “initial viscosity”) of the two-pack curable epoxy resin composition of the present invention at 30° C. is preferably in a range of 100 to 3000 mPa·s, because the two-pack curable epoxy resin composition having excellent impregnation property into the reinforcing fiber can be obtained and moldability is excellent. Note that the viscosity in the present invention is a value measured using an E-type viscometer.

The “initial viscosity” in the present invention refers to the viscosity immediately after compounding.

Further, it is preferred that the “initial viscosity” and a viscosity after a lapse of eight hours at 30° C. (hereinafter, abbreviated as “viscosity after eight hours”) satisfy a relationship of the following equation (1), because it is possible to obtain the two-pack curable epoxy resin composition having a long usable time and excellent impregnation property into the reinforcing fiber.

[Equation 2]

“Viscosity after eight hours”/“Initial viscosity”≤2 (1)

The two-pack curable epoxy resin composition of the present invention contains the curing agent having excellent long-term storage stability that does not cause a decarboxylation reaction, has excellent impregnation property into the reinforcing fiber, and has excellent mechanical strength, heat resistance and surface smoothness in the cured product to be obtained, so that it can be used for various uses such as paints, electric/electronic materials, adhesives, and molded articles. The two-pack curable epoxy resin composition of the present invention can be suitably used not only for uses in which it is cured to be used, but also for fiber-reinforced composite materials, fiber-reinforced resin molded articles, and the like. These will be described below.

Cured Product of Two-Pack Curable Epoxy Resin Composition

The cured product of the present invention is obtained by subjecting the two-pack curable epoxy resin composition containing the main agent (i) and the curing agent (ii) to a curing reaction. A method for obtaining the cured product is not particularly limited, and examples thereof include a method of kneading the main agent (i) and the curing agent (ii) using a kneading machine.

Examples of the kneading machine include an extruder, a heating roll, a kneader, a roller mixer, a Banbury mixer, and the like.

Further, the curing reaction may be based on a general curing method for a curable resin composition, and heating temperature conditions can be appropriately selected depending on a type, use, and the like of the curing agent to be combined. For example, a method of heating the two-pack curable epoxy resin composition in a temperature range of room temperature to about 250° C. can be mentioned. Further, a general curable resin composition method can be used as a molding method and the like, and conditions peculiar to the two-pack curable epoxy resin composition of the present invention are not particularly required.

Fiber Reinforced Composite Material

The fiber-reinforced composite material of the present invention is a material in a state before curing after impregnating the reinforcing fiber with the two-pack curable epoxy resin composition. Here, the reinforcing fiber may be any of twisted yarn, untwisted yarn, zero-twist yarn and the like, but the untwisted yarn and the zero-twist yarn are preferable because they have excellent moldability in the fiber-reinforced composite material. Further, as a form of the reinforcing fiber, one in which fiber directions are aligned in one direction or a woven fabric can be used. For the woven fabric, a plain weave, a satin weave, or the like can be freely selected depending on a part to be used and an intended use. Specific examples thereof include carbon fiber, glass fiber, aramid fiber, boron fiber, alumina fiber, and silicon carbide fiber, because they have excellent mechanical strength and durability, and they can be used alone or in combination of two or more. Among them, the carbon fiber is preferable especially from a viewpoint of improving strength of the molded article, and various carbon fibers such as polyacrylonitrile-based, pitch-based, and rayon-based can be used.

A method for obtaining the fiber-reinforced composite material from the two-pack curable epoxy resin composition of the present invention is not particularly limited, but examples thereof include a method in which the components constituting the two-pack curable epoxy resin composition are uniformly mixed to produce a varnish, and then a unidirectional reinforcing fiber having reinforcing fibers aligned in one direction is immersed with the obtained varnish (a state before curing in a pultrusion method or a filament winding method), a method in which the woven fabric of the reinforcing fiber is stacked and set in a concave mold, and then sealed with a convex mold, and the resin is injected and pressure impregnated (a state before curing in an RTM method), and the like.

In the fiber-reinforced composite material of the present invention, the two-pack curable epoxy resin composition does not necessarily have to be impregnated to an inside of a fiber bundle, and the two-pack curable epoxy resin composition may be in a state of being localized near a surface of the fiber.

Further, in the fiber-reinforced composite material of the present invention, a volume content of the reinforcing fiber with respect to a total volume of the fiber-reinforced composite material is preferably in a range of 40% to 85%, and more preferably in a range of 50% to 70% from a viewpoint of the strength. When the volume content is 40% or more, a content of the two-pack curable epoxy resin composition is appropriate, and it easy to satisfy various properties required for the fiber-reinforced composite material having excellent flame retardancy, specific elastic modulus and specific strength of the obtained cured product. Further, when the volume content is 85% or less, adhesiveness between the reinforcing fiber and the two-pack curable epoxy resin composition is good.

Fiber Reinforced Resin Molded Article

The fiber-reinforced resin molded article of the present invention is a molded article having the reinforcing fiber and the cured product of the two-pack curable epoxy resin composition, and is obtained by thermosetting the fiber-reinforced composite material. As the fiber-reinforced resin molded article of the present invention, specifically, the volume content of the reinforcing fiber in the fiber-reinforced molded article is preferably in a range of 40% to 85%, and particularly preferably in a range of 50% to 70% from the viewpoint of the strength. Examples of such a fiber-reinforced resin molded article include automobile parts such as a front subframe, a rear subframe, a front pillar, a center pillar, a side member, a cross member, a side sill, a roof rail, and a propeller shaft, core members of electric wire cables, pipe materials for submarine oil fields, roll pipe materials for printing machines, robot fork materials, primary structural materials, and secondary structural materials for aircraft.

A method for obtaining the fiber-reinforced molded article from the two-pack curable epoxy resin composition of the present invention is not particularly limited, but it is preferable to use the pultrusion method, the filament winding method, the RTM method, or the like. The pultrusion method is a method of molding the fiber-reinforced resin molded article by introducing the fiber-reinforced composite material into a mold, heat-curing it, and then pulling it out with a drawing device, the filament winding method is a method of molding the fiber-reinforced resin molded article by winding the fiber-reinforced composite material (including a unidirectional fiber) around an aluminum liner, a plastic liner, or the like while rotating it, and then heat-curing it, and the RTM method is a method of using two types of molds, the concave mold and the convex mold, and of heat curing the fiber reinforced composite material in the mold to form the fiber reinforced resin molded article. When molding a large-sized article or the fiber-reinforced resin molded article having a complicated shape, it is preferable to use the RTM method.

As molding conditions for the fiber-reinforced resin molded article, it is preferable to mold it by heat-curing the fiber-reinforced composite material in a temperature range of 50° C. to 250° C., and is more preferable to mold it in a temperature range of 70° C. to 220° C. This is because if a molding temperature is too low, sufficient rapid curing may not be obtained, and conversely, if it is too high, warpage due to thermal strain may easily occur. Examples of other molding conditions include a method of curing in two steps, for example, pre-curing the fiber-reinforced composite material at 50° C. to 100° C. to form a tack-free cured product, and then further treating it at a temperature condition of 120° C. to 200° C.

Examples of other methods for obtaining the fiber-reinforced molded article from the two-pack curable epoxy resin composition of the present invention include a hand lay-up method or spray-up method of laying fiber aggregate in the mold and laminating the varnish and the fiber aggregate in multiple layers, a vacuum bag method of using either a male or female mold and of laminating and molding substrates made of reinforcing fibers while impregnating them with varnish, covering them with a flexible mold capable of applying pressure to the molded article, and vacuum (reduced pressure) molding airtightly sealed molded article, and an SMC press method of compression molding a sheet of varnish containing reinforcing fibers prepared in advance with the mold.

### EXAMPLES

Hereinafter, the present invention will be specifically described with reference to Examples and Comparative Examples.

### Synthesis Example 1: Production of Curing Agent (1)

91.3 parts by mass of methyltetrahydrophthalic anhydride (amount of free acid; 0.2 mass %, acid anhydride equivalent: 166 g/eq) and 3.8 parts by mass of triphenylphosphine were charged in a four-necked flask with a nitrogen introduction tube, a cooling tube, a thermometer and a stirrer, and heated to 60° C. Then, the mixture was stirred for one hour, and it was confirmed that triphenylphosphine was dissolved, to obtain the curing agent (1).

### Synthesis Examples 2 to 8: Production of Curing Agents (2) to (8)

The curing agents (2) to (8) were obtained in the same manner as in Synthesis Example 1 except that the compositions and blending amounts shown in Table 1 were used. In the curing agent (7) obtained in Synthesis Example 7, 200 mL or more of the curing agent was placed in a 250 mL square can and sealed, and the can was slightly swollen after being left at 40° C. for 14 days, but it was confirmed that swelling of the curing agent (7) was not more than half when compared with the curing agent (8) obtained in Synthesis Example 8.

TABLE 1

| | | Synthesis | Synthesis | Synthesis | Synthesis | Synthesis | Synthesis | Synthesis | Synthesis |
|---|---|---|---|---|---|---|---|---|---|
| | | Example 1 | Example 2 | Example 3 | Example 4 | Example 5 | Example 6 | Example 7 | Example 8 |
| Curing agent | | (1) | (2) | (3) | (4) | (5) | (6) | (7) | (8) |
| Methyltetrahydrophthalic | Composition | 91.3 | 91.3 | 91.3 | 91.3 | 91.3 | 91.3 | 91.3 | 91.3 |
| anhydride | (Parts by | | | | | | | | |
| Triphenyl phosphine | mass) | 3.8 | 1.9 | | | | 0.7 | 13.5 | |
| Tributyl phosphine | | | | 3.8 | | | | | |
| Triphenyl phosphite | | | | | 3.8 | | | | |
| Triphenyl phosphate | | | | | | 3.8 | | | |
| 1,2-dimethylimidazole | | | | | | | | | 1.9 |

### Examples 1 to 5: Preparation of Two-Pack Curable Epoxy Resin Compositions (1) to (5)

The components were blended according to the formulation shown in Table 2 below, and uniformly stirred and mixed to obtain the two-pack curable epoxy resin compositions (1) to (5).

### Comparative Examples 1 to 5: Preparation of Two-Pack Curable Epoxy Resin Compositions (C1) to (C5)

The components were blended according to the formulation shown in Table 2 below, and uniformly stirred and mixed to obtain the two-pack curable epoxy resin compositions (C1) to (C2).

The following evaluations were performed using the two-pack curable epoxy resin compositions obtained in Examples 1 to 5 and Comparative Examples 1 to 5 described above.

### [Method for Measuring Viscosity]

Using the E-type viscometer (“TV-22” manufactured by Toki Sangyo Co., Ltd.), the initial compound viscosity “initial viscosity” of the two-pack curable epoxy resin composition at 30° C., and the “viscosity after eight hours” after eight hours have passed were measured.

### [Method for Measuring DSC]

The exothermic temperature range was measured by a differential scanning calorimetry apparatus (“DSC1” manufactured by METTOLER TOLEDO, amount of sample 4.0-8.0 mg, size of aluminum sample pan φ5×2.5 mm, temperature rise rate 10° C./min, flow rate of nitrogen 40 ml/min, temperature range 25 to 250° C.). Note that the “Onset temperature” and the “Endset temperature” were automatically calculated by a computer.

### [Method for Evaluating Mechanical Properties]

The mechanical strength was evaluated by measuring bending strength and flexural modulus.

### <Measurement of Bending Strength and Flexural Modulus>

The two-pack curable epoxy resin compositions obtained in Examples and Comparative Example were poured into the mold having a width of 90 mm, a length of 110 mm, and a thickness of 4 mm, and thermoset in a dryer at 120° C. for 15 minutes, to obtain the cured products. The bending strength and the flexural modulus of the obtained cured product were measured in accordance with JIS K 6911 (2006).

### [Method for Evaluating Heat Resistance]

The two-pack curable epoxy resin compositions obtained in Examples and Comparative Examples were poured into the mold having a width of 90 mm, a length of 110 mm, and a thickness of 2 mm, and thermoset in the dryer at 120° C. for 15 minutes, to obtain the cured products. The obtained cured product was cut into a width of 5 mm and a length of 55 mm with a diamond cutter, and this was used as a test piece. Subsequently, dynamic viscoelasticity in a dual cantilever bending mode under the following conditions was measured using “DMS6100” manufactured by SII NanoTechnology, Inc., and a temperature at which tan δ was the maximum value was evaluated as a glass transition temperature (Tg).

Measurement conditions for measuring the dynamic viscoelasticity were temperature conditions: room temperature to 260° C., temperature rise rate: 3° C./min, frequency: 1 Hz (sine wave), and strain amplitude: 10 μm.

### [Method for Evaluating Surface Smoothness]

The two-pack curable epoxy resin compositions obtained in Examples and Comparative Examples were poured into the mold having a width of 90 mm, a length of 110 mm, and a thickness of 4 mm, and thermoset in the dryer at 120° C. for 15 minutes to obtain the cured products. The obtained cured product was cut into a width of 50 mm and a length of 50 mm with the diamond cutter, and this was used as the test piece. The number of bubbles on a surface of the test piece was checked and evaluated according to the following criteria.

A: The number of bubbles on the surface of the test piece was less than 5.

B: The number of bubbles on the surface of the test piece was 5 or more and less than 10.

C: The number of bubbles on the surface of the test piece was 10 or more.

Table 2 shows the compositions and evaluation results of the two-pack curable epoxy resin compositions (1) to (5) and (C1) to (C5) obtained in Examples 1 to 5 and Comparative Examples 1 to 5.

TABLE 2

| | | Exam- | Exam- | Exam- | Exam- | Exam- | Comparative | Comparative | Comparative | Comparative | Comparative |
|---|---|---|---|---|---|---|---|---|---|---|---|
| | | ple 1 | ple 2 | ple 3 | ple 4 | ple 5 | Example 1 | Example 2 | Example 3 | Example 4 | Example 5 |
| Two-pack curable epoxy | | (1) | (2) | (3) | (4) | (5) | (C1) | (C2) | (C3) | (C4) | (C5) |
| resin composition | | | | | | | | | | | |
| Bisphenol A type | Compo- | 100 | 100 | 100 | 100 | 100 | 100 | 100 | 100 | 100 | 100 |
| epoxy resin | sition | | | | | | | | | | |
| Curing agent (1) | (Parts by | 95.1 | | | | | 190 | 30 | | | |
| Curing agent (2) | mass) | | 93.2 | | | | | | | | |
| Curing agent (3) | | | | 95.1 | | | | | | | |
| Curing agent (4) | | | | | 95.1 | | | | | | |
| Curing agent (5) | | | | | | 95.1 | | | | | |
| Curing agent (6) | | | | | | | | | 92 | | |
| Curing agent (7) | | | | | | | | | | 104.8 | |
| Curing agent (8) | | | | | | | | | | | 93.2 |

| | | | | | | | | | | |
|---|---|---|---|---|---|---|---|---|---|---|
| Initial viscosity | 255 | 250 | 260 | 270 | 270 | 50 | 2000 | 240 | 300 | 350 |
| [mPa · s] | | | | | | | | | | |
| Viscosity after eight | 350 | 300 | 370 | 400 | 410 | 70 | 5500 | 290 | 900 | 850 |
| hours [mPa · s] | | | | | | | | | | |
| “Viscosity after | 1.37 | 1.20 | 1.42 | 1.48 | 1.52 | 1.40 | 2.75 | 1.21 | 3.00 | 2.43 |
| eight hours”/“Initial | | | | | | | | | | |
| viscosity” | | | | | | | | | | |
| DSC Onset [° C.] | 119 | 130 | 122 | 125 | 135 | 140 | 138 | 135 | 105 | 111 |
| DSC Endset [° C.] | 155 | 160 | 158 | 160 | 170 | 180 | 185 | 169 | 130 | 154 |
| “Endset” − “Onset” | 36 | 30 | 36 | 35 | 35 | 40 | 47 | 34 | 25 | 43 |
| [° C.] | | | | | | | | | | |
| Bending strength | 122 | 120 | 118 | 117 | 115 | 75 | 70 | 95 | 119 | 119 |
| [MPa] | | | | | | | | | | |
| Flexural modulus | 3070 | 3110 | 3050 | 3020 | 3010 | 2100 | 2020 | 2700 | 3000 | 2930 |
| [MPa] | | | | | | | | | | |
| Heat resistance Tg | 140 | 138 | 130 | 135 | 130 | 80 | 75 | 105 | 139 | 134 |
| [° C.] | | | | | | | | | | |
| Surface smoothness | ◯ | ◯ | ◯ | ◯ | Δ | Δ | ◯ | ◯ | X | X |

Note that the “Bisphenol A type epoxy resin” in Table 2 indicates “EPICLON 840-S (epoxy equivalent: 184 g/eq)” produced by DIC Corporation.

1. A two-pack curable epoxy resin composition comprising:
a main agent (i) containing an epoxy resin (A); and
a curing agent (ii) containing an acid anhydride (B) and an organic phosphorus compound (C), wherein
a mass ratio [(i)/(ii)] of the main agent (i) to the curing agent (ii) is in a range of 35/65 to 75/25, and
an amount of the organic phosphorus compound (C) used is in a range of 0.5 to 5 parts by mass with respect to 100 parts by mass in total of the epoxy resin (A) and the acid anhydride (B).

2. The two-pack curable epoxy resin composition according to claim 1, wherein in the curing agent (ii), the amount of the organic phosphorus compound (C) used is in a range of 1.0 to 10 parts by mass with respect to 100 parts by mass of the acid anhydride (B).

3. The two-pack curable epoxy resin composition according to claim 1, wherein the organic phosphorus compound (C) is a trivalent organic phosphorus compound.

4. The two-pack curable epoxy resin composition according to claim 1, wherein the organic phosphorus compound (C) is triphenylphosphine.

5. The two-pack curable epoxy resin composition according to claim 1, wherein an amount of free acid contained in the acid anhydride (B) is in a range of 0.05 to 2 mass %.

6. The two-pack curable epoxy resin composition according to claim 1, wherein the main agent (i) and the curing agent (ii) are used so that an epoxy equivalent of the epoxy resin (A) is in a range of 130 to 230 g/eq, an acid anhydride equivalent of the acid anhydride (B) is in a range of 150 to 190 g/eq, and “the number of moles of acid anhydride group”/“the number of moles of epoxy group” is in a range of 0.8 to 1.2.

7. The two-pack curable epoxy resin composition according to claim 1, wherein an exothermic temperature range (“Endset temperature”-“Onset temperature”) in a DSC measurement of the two-pack curable epoxy resin composition is in a range of 20 to 38° C.

8. The two-pack curable epoxy resin composition according to claim 1, wherein an initial composition viscosity “initial viscosity” of the two-pack curable epoxy resin composition at 30° C. is in a range of 100 to 3000 mPa·s, and the “initial viscosity” and a viscosity after a lapse of eight hours “viscosity after eight hours” at 30° C. satisfy a relationship of the following equation (1).
[Equation 1]
“Viscosity after eight hours”/“Initial viscosity”≤2 (1)

9. A cured product which is a curing reaction product of the two-pack curable epoxy resin composition according to claim 1.

10. A fiber-reinforced composite material comprising the two-pack curable epoxy resin composition according to claim 1 and a reinforcing fiber.

11. A molded article made of the fiber-reinforced composite material according to claim 10.

12. The two-pack curable epoxy resin composition according to claim 2, wherein the organic phosphorus compound (C) is a trivalent organic phosphorus compound.

13. The two-pack curable epoxy resin composition according to claim 2 wherein the organic phosphorus compound (C) is triphenylphosphine.

14. The two-pack curable epoxy resin composition according to claim 3 wherein the organic phosphorus compound (C) is triphenylphosphine.

15. The two-pack curable epoxy resin composition according to claim 2, wherein an amount of free acid contained in the acid anhydride (B) is in a range of 0.05 to 2 mass %.

16. The two-pack curable epoxy resin composition according to claim 2, wherein the main agent (i) and the curing agent (ii) are used so that an epoxy equivalent of the epoxy resin (A) is in a range of 130 to 230 g/eq, an acid anhydride equivalent of the acid anhydride (B) is in a range of 150 to 190 g/eq, and “the number of moles of acid anhydride group”/“the number of moles of epoxy group” is in a range of 0.8 to 1.2.

17. The two-pack curable epoxy resin composition according to claim 2, wherein an exothermic temperature range (“Endset temperature”-“Onset temperature”) in a DSC measurement of the two-pack curable epoxy resin composition is in a range of 20 to 38° C.

18. The two-pack curable epoxy resin composition according to claim 2, wherein an initial composition viscosity “initial viscosity” of the two-pack curable epoxy resin composition at 30° C. is in a range of 100 to 3000 mPa-s, and the “initial viscosity” and a viscosity after a lapse of eight hours “viscosity after eight hours” at 30° C. satisfy a relationship of the following equation (1).
[Equation 1]
“Viscosity after eight hours”/“Initial viscosity”≤2 (1)

19. A cured product which is a curing reaction product of the two-pack curable epoxy resin composition according to claim 2.

20. A fiber-reinforced composite material comprising the two-pack curable epoxy resin composition according to claim 2 and a reinforcing fiber.
